(19) United States
(12) Patent Application Publication
(10) Pub. No.: US 2012/0318240 A1
(43) Pub. Date: Dec. 20, 2012

(54) ARRANGEMENT STRUCTURE FOR DRIVE CIRCUIT

(75) Inventors: Ryuji Aso, Shioya-gun (JP); Hiaki Sugawara, Shioya-gun (JP)

(73) Assignee: KEIHIN CORPORATION, Tokyo (JP)

(21) Appl. No.: 13/580,579

(22) PCT Filed: Mar. 15, 2011
(86) PCT No.: PCT/JP2011/056022

§ 371 Date: Aug. 22, 2012

(30) Foreign Application Priority Data
Mar. 25, 2010 (JP) 2010-070998

(51) Int. Cl. F02D 41/02; F02D 41/26

(52) U.S. Cl. 123/480

(57) ABSTRACT

A shortest distance (d) between a drive circuit (4) and an electric wire (8b) is set such that an electric field caused by an electric current flowing in the electric wire (8b) that electrically connects an ignition-voltage generating device (IG) and an ignition plug (6) induces a surge voltage to the drive circuit (4) via an electrostatic capacity (Cm) between the drive circuit (4) that can freely inject fuel from a fuel injection device (7) provided in an internal-combustion engine (5) to the internal-combustion engine (5) under control of a microcomputer and the electric wire (8b), and the surge voltage becomes equal to or lower than predetermined surge withstanding capability of the semiconductor power device.

### TECHNICAL FIELD

The present invention relates to an arrangement structure for a drive circuit, and more particularly relates to an arrangement structure for a drive circuit for fuel injection of an internal-combustion engine.

### BACKGROUND ART

In recent years, more sophisticated functions of various electric components incorporated in a vehicle such as a car have been demanded, and there has been a recent trend that various drive circuits are used under control of an in-vehicle microcomputer and control of operations of the drive circuits are executed in a precise manner.

In many cases, these electric components are an inductance load having a coil such as a motor or an actuator incorporated therein, and when a drive circuit of the inductance load is operated and an electric component is turned off, there is a case where a surge voltage having a counter-electromotive force is applied on the drive circuit. Such a surge voltage to the drive circuit is a high voltage in many cases, and thus it is necessary to set that the breakdown withstanding capability of the drive circuit to the surge voltage to be a large value with some margin.

Patent Document 1 relates to an ignition device for an internal-combustion engine including a control IC 22, and discloses a configuration such that the control IC 22 includes a protection circuit 25 that protects a control circuit from high voltage surge such as static electricity and ignition noise as well as an internal control circuit 23. The protection circuit 25 includes elements such as an NPN transistor 30 formed by an n⁻ layer 26 stacked on a p⁻ layer 27, a p⁺ base region 29 formed on an n⁻ layer, an n⁺ collector region 33 formed in a p⁺ base region, and an n⁺ emitter region 37 formed on an n⁻ layer and overlapping with a p⁺ base region and the like.

Patent Document 2 relates to an ignition device for an internal-combustion engine including a control circuit IC 3, and discloses a configuration such that the control circuit IC 3 includes a protection element 10 having an NPN transistor 13 in which a collector terminal is connected to a signal line to which an ignition signal in the control circuit IC 3 is input and an emitter terminal is connected to a ground (GND), a condenser 14 present between a base and an emitter in the NPN transistor 13, and a parasitic diode 13a present between a collector and an emitter of the NPN transistor 13, and that a circuit part to which an ignition signal is input is protected from extraneous surge while avoiding size increase.

### PRIOR ART DOCUMENT

### Patent Documents

Patent Document 1: Japanese Patent Application Laid-open No. 2004-335979
Patent Document 2: Japanese Patent Application Laid-open No. 2006-46256

### SUMMARY OF THE INVENTION

### Problem to be Solved by the Invention

According to studies of the present inventors, in the configurations of Patent Document 1 and Patent Document 2, the protection circuit 25 or the protection element 10 is provided to employ a configuration in which high breakdown withstanding capability is realized so that the control IC 22 or the control circuit IC 3 is protected from a surge voltage; however, when the configuration is implemented in a vehicle in practice, a surge voltage induced from other wires or electric components sometimes becomes larger than an assumed value, and thus there is a case where it is necessary to employ a configuration that can realize much higher breakdown withstanding capability.

Producing a semiconductor circuit with high breakdown withstanding capability to have even higher breakdown withstanding capability means developing a semiconductor circuit with a more unique configuration, and this development is not ideal as far as the time and cost-effectiveness are concerned.

Furthermore, a technique of reducing a surge voltage by employing an additional configuration to other electric components or the like that induce the surge voltage of an unexpected value is also not ideal as far as the time and cost-effectiveness are concerned, because of an increase in the number of parts.

That is, there has been desired a configuration related to a semiconductor circuit that can securely reduce a surge voltage with a simple configuration when a surge voltage induced from other wires or electric components is large, without causing the semiconductor device to have even higher breakdown withstanding capability or employing an additional configuration to the electric components or the like that induce the surge voltage.

The present invention has been achieved in view of the above studies, and an object of the present invention is to provide an arrangement structure for a semiconductor circuit such as a drive circuit that can securely reduce a surge voltage with a simple configuration, without causing the semiconductor device to have even higher breakdown withstanding capability or employing an additional configuration to electric components or the like that induce a surge voltage.

### Means for Solving the Problem

To achieve the above object, a first aspect of the present invention provides an arrangement structure for a drive circuit that comprises a drive circuit that can freely inject fuel from a fuel injection device provided in an internal-combustion engine to the internal-combustion engine under control of a microcomputer, and an electric wire that electrically connects an ignition-voltage generating device that can freely apply an ignition voltage to an ignition plug provided in the internal-combustion engine and the ignition plug, wherein the drive circuit includes a semiconductor power device that is configured to have high breakdown withstanding capability to have predetermined surge withstanding capability, and a shortest distance between the drive circuit and the electric wire is set such that an electric field caused by an electric current flowing in the electric wire induces a surge voltage to the drive circuit via an electrostatic capacity between the drive circuit and the electric wire, and the surge voltage becomes equal to or lower than the predetermined surge withstanding capability of the semiconductor power device.

According to a second aspect of the present invention, in addition to the first aspect, when a frequency of the ignition voltage flowing in the electric wire is designated as f (Hz), a maximum voltage of the ignition voltage is designated as Vng (V), the electrostatic capacity in a case where air is present between the electric wire and the drive circuit is designated as Cm (F), an input impedance of the drive circuit is designated as Zi (Ω), and the surge voltage generated in the drive circuit is designated as Vni (V), the shortest distance between the drive circuit and the electric wire is set by determining the electrostatic capacity between the drive circuit and the electric wire such that the surge voltage obtained from following equation (Equation 1) becomes equal to or lower than the predetermined surge withstanding capability of the semiconductor power device.

Vni=2π·f·Cm·Zi·Vng [Equation 1]

According to a third aspect of the present invention, in addition to the first or second aspects, the drive circuit is arranged on an upper part of the internal-combustion engine, and the electric wire extends from an upper portion of the internal-combustion engine.

According to a fourth aspect of the present invention, in addition to any one of the first to third aspects, the electric wire includes a metal core and a sheath coating around the metal core by resin.

According to a fifth aspect of the present invention, in addition to any one of the first to fourth aspects, the drive circuit and the microcomputer are arranged in a same package.

### Effect of the Invention

According to the arrangement structure for a drive circuit of the first aspect of the present invention, the shortest distance between the drive circuit and the electric wire is set such that an electric field caused by an electric current flowing in the electric wire that electrically connects the ignition-voltage generating device and the ignition plug induces a surge voltage to the drive circuit via an electrostatic capacity between the drive circuit and the electric wire, and the surge voltage becomes equal to or lower than predetermined surge withstanding capability of the semiconductor power device of the drive circuit. Therefore, the surge voltage can be securely reduced with a simple configuration without having even higher breakdown withstanding capability or employing an additional configuration to other electric components or the like that induce the surge voltage, and it is possible to securely prevent the drive circuit from being influenced by an unnecessary surge voltage.

According to the arrangement structure for a drive circuit of the second aspect of the present invention, the shortest distance between the drive circuit and the electric wire is set by determining the electrostatic capacity between the drive circuit and the electric wire that electrically connects the ignition-voltage generating device and the ignition plug such that the surge voltage obtained from the equation (Equation 1) becomes equal to or lower than the predetermined surge withstanding capability of the semiconductor power device. Therefore, the surge voltage can be securely reduced while the drive circuit is arranged based on a unified principle, and it is possible to securely prevent the drive circuit from being influenced by an unnecessary surge voltage.

According to the arrangement structure for a drive circuit of the third aspect of the present invention, the drive circuit is arranged on an upper part of the internal-combustion engine, and the electric wire that electrically connects the ignition-voltage generating device and the ignition plug extends from an upper portion of the internal-combustion engine. Therefore, even when it is a configuration in which the drive circuit and the electric wire are close to each other, the surge voltage can be securely reduced, and thus it is possible to securely prevent the drive circuit from being influenced by an unnecessary surge voltage.

According to the arrangement structure for a drive circuit of the fourth aspect of the present invention, even when the electric wire that electrically connects the ignition-voltage generating device and the ignition plug has a simple configuration such that the electric wire includes a metal core and a sheath coating around the metal core by resin, the surge voltage can be reduced. Therefore, even without employing any electric wire having a unique blocking structure, it is possible to securely prevent the drive circuit from being influenced by an unnecessary surge voltage.

According to the arrangement structure for a drive circuit of the fifth aspect of the present invention, because the drive circuit and the microcomputer are arranged in a same package, the entirety of a device configuration can be made compact while securely preventing the drive circuit from being influenced by an unnecessary surge voltage.

### BRIEF DESCRIPTION OF THE DRAWINGS

FIG. 1A block diagram showing a connecting structure between an electronic control unit and an internal-combustion engine according to an embodiment of the present invention.

FIG. 2 A side view of relevant parts of an internal-combustion engine to which a drive circuit according to the embodiment is connected.

FIG. 3 A waveform diagram showing a secondary voltage generated in a secondary coil of an ignition coil under control of a microcomputer of the electronic control unit according to the embodiment.

FIG. 4 A schematic diagram of an equivalent circuit showing a relationship between the drive circuit according to the embodiment and an electric wire that electrically connects an ignition coil and an ignition plug.

FIG. 5 A graph showing a coupling electrostatic capacity between the drive circuit according to the embodiment and an electric wire that electrically connects an ignition coil and an ignition plug.

FIG. 6 A cross-sectional view showing a structure in which the microcomputer, the drive circuit and the like according to the embodiment are arranged in the same package and stacked therein.

### EMBODIMENT FOR CARRYING OUT THE INVENTION

An arrangement structure for a drive circuit according to an embodiment of the present invention will be explained below in detail with reference to the accompanying drawings while exemplifying a case of controlling fuel injection of an internal-combustion engine.

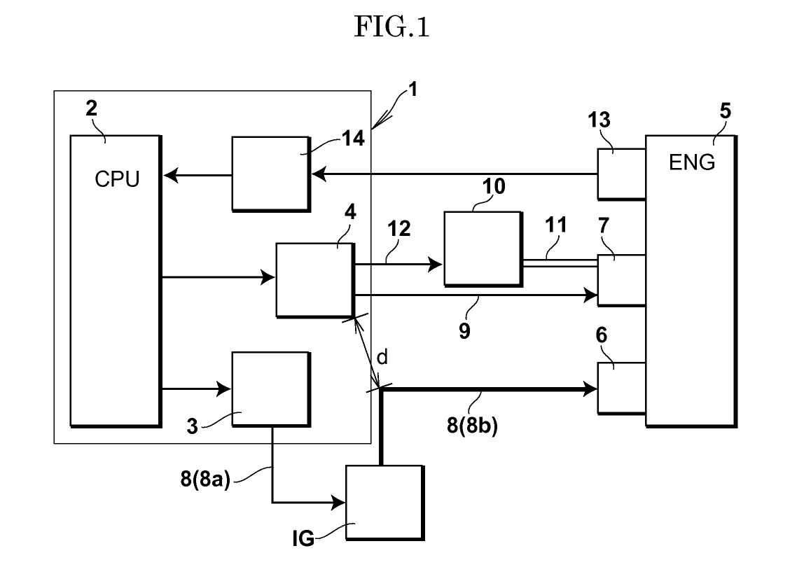

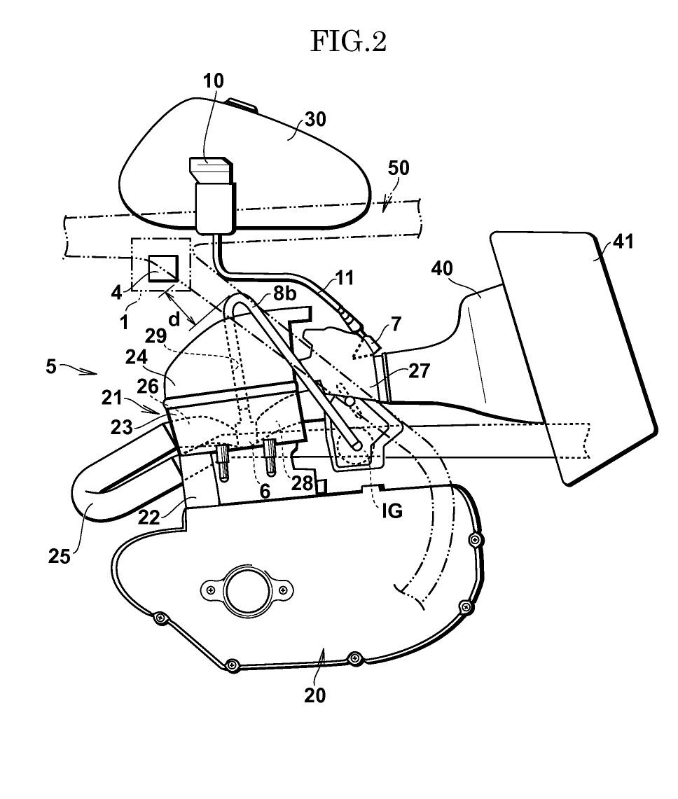

First, configurations of the periphery of a drive circuit according to the present embodiment are explained below in detail with reference to FIG. 1 and FIG. 2.

FIG. 1 is a block diagram showing a connecting structure between an electronic control unit and an internal-combustion engine according to the present embodiment. FIG. 2 is a side view of relevant parts of an internal-combustion engine to which the drive circuit according to the present embodiment is connected.

As shown in FIG. 1, an ECU (Electronic Control Unit) 1 includes a CPU (Central Processing Unit) 2 that is a microcomputer, an ignition circuit 3 having incorporated therein a switching element, such as a transistor, that is operated under control of the CPU 2, and a drive circuit 4 having incorporated therein a switching element, such as a transistor, that is operated under control of the CPU 2. The ECU 1 is electrically connected to an ignition plug 6 and a fuel injection device 7 respectively provided in an internal-combustion engine 5. The CPU 2 includes an arithmetic processing device (not shown) and necessary memory devices and controls the entire operations of the internal-combustion engine 5.

Specifically, in the ECU 1, the ignition circuit 3 is electrically connected to the ignition plug 6 provided in the internal-combustion engine 5 by an electric wire 8. Specifically, as for the ignition circuit 3, the ignition circuit 3 and an ignition coil IG are electrically connected by an electric wire 8a, where the ignition coil IG generates a high-voltage secondary voltage, which is an ignition voltage generated by a switching operation of the ignition circuit 3. Furthermore, the ignition coil IG and the ignition plug 6 are electrically connected by an electric wire 8b, and thus the ignition circuit 3 is electrically connected to the ignition plug 6. A secondary voltage generated by the ignition coil IG is applied to the ignition plug 6, and an ignition spark is applied to fuel and air mixture in a combustion chamber (not shown) in the internal-combustion engine 5. An ignition-voltage generating device for generating an ignition voltage is not limited to an ignition coil, and a capacitor electrically connected to a power generator or the like that is separately provided in an internal-combustion engine can be also used.

In the ECU 1, the drive circuit 4 is electrically connected to the fuel injection device 7 provided in the internal-combustion engine 5 by an electric wire 9. Meanwhile, a fuel pump 10 is connected to the fuel injection device 7 via a fuel pipe 11 such that the fuel pump 10 can freely supply fuel with a constant high pressure level, and the fuel pump 10 is electrically connected to the CPU 2 via an electric wire 12 and the drive circuit 4. The fuel injection device 7 has an actuator (not shown) incorporated therein, operates the actuator by a switching operation of the drive circuit 4, and injects fuel supplied from the fuel pump 10 from a nozzle (not shown) provided at a tip end of the fuel injection device 7 to the vicinity of the combustion chamber (not shown) in the internal-combustion engine 5. The fuel injection device 7 can also employ a configuration in which fuel is directly injected into the combustion chamber in the internal-combustion engine 5.

As a switching element in the ignition circuit 3 and the drive circuit 4, a so-called power semiconductor device such as a power transistor, a power MOSFET (Metal-Oxide Semiconductor Field-Effect Transistor), an IGBT (Insulated Gate Bipolar Transistor), a BSIT (Bipolar mode Static Induction Transistor) is used. Particularly in consideration of a fact that a load is the ignition coil IG or the fuel injection device 7, the switching element is given high breakdown withstanding capability so as to have sufficient surge withstanding capability to a counter-electromotive force at the time of turning it off. Although not limited thereto, examples of the configuration of having high breakdown withstanding capability include a configuration having a zener diode added thereto or that reduces a parasitic diode.

In the ECU 1, in order to control the ignition circuit 3 and the drive circuit 4, various input circuits 14 to which a detection signal from various sensors 13 arranged in the internal-combustion engine 5 is input, are provided; however, for convenience sake, one sensor 13 and one input circuit 14 are shown in FIG. 1.

As shown in FIG. 2, the internal-combustion engine 5 includes a crank case 20 that accommodates a crank (not shown) and a cylinder 21 having a combustion chamber (not shown). The cylinder 21 includes a cylinder block 22, a cylinder head 23, and ahead cover 24 to have them directed upward from the crank case 20, and the cylinder 21 is typically arranged to be upright.

A combustion chamber is formed in the cylinder block 22. An exhaust passage 26 communicated with an exhaust pipe 25 and a suction passage 28 communicated with a throttle body 27 are formed in the cylinder head 23, and the ignition plug 6 is arranged to face a combustion chamber of the cylinder block 22. An insertion hole 29 having inserted therein the electric wire 8b, which is a so-called high-tension code that electrically connects the ignition coil IG supported at a lower part of the throttle body 27 and the ignition plug 6, is formed in the head cover 24. An air cleaner 41 is communicated with the throttle body 27 via a communication pipe 40.

A fuel tank 30 is arranged at an upper part of the head cover 24, and the fuel tank 30 supports the fuel pump 10 communicated with fuel stored therein. The fuel pump 10 can freely supply fuel with a constant high pressure level to the fuel injection device 7 provided in the throttle body 27 via the fuel pipe 11. While the electric wire 9 that electrically connects the drive circuit 4 and the fuel injection device 7 is wired along the fuel pipe 11, for convenience sake, the electric wire 9 is not shown in FIG. 2.

The ECU 1 including the CPU 2, the ignition circuit 3, the drive circuit 4, and the input circuit 14, as well as the internal-combustion engine 5 and the fuel tank 30, are supported by a frame 50, which is a framework member of a vehicle. Particularly in a vehicle such as a motorcycle, due to its design layout, there is a case where the drive circuit 4 and the like has to be arranged in a narrow space above the cylinder head 23 of the internal-combustion engine 5 and around the fuel tank 30. In this case, there may be a state where the electric wire 8b that extends upward from the insertion hole 29 of the cylinder head 23 and electrically connects the ignition coil IG and the ignition plug 6 is routed while being close to the drive circuit 4. For convenience sake, the CPU 2, the ignition circuit 3, and the input circuit 14 are not shown in FIG. 2.

A combustion operation in the internal-combustion engine 5 having the above configuration is explained below in detail.

As for supplying a mixture of fuel and air, while fuel with a constant high pressure level is supplied from the fuel pump 10 to the fuel injection device 7 via the fuel pipe 11 under control of the CPU 2, the actuator of the fuel injection device 7 electrically connected to the drive circuit 4 via the electric wire 9 is operated by a switching operation of the drive circuit 4, and fuel is injected from a nozzle formed at a tip end of the fuel injection device 7 to the inside of the throttle body 27 with a predetermined time interval. Subsequently, the fuel injected in this way is mixed with air introduced from the communication pipe 40, and then supplied to a combustion chamber formed in the cylinder block 22 through the suction passage 28.

Meanwhile, as for ignition of the mixture, as the ignition circuit 3 performs a switching operation under control of the CPU 2, the ignition coil IG generates a high-voltage secondary voltage as an ignition voltage, and the secondary voltage is applied to the ignition plug 6 arranged to face the combustion chamber of the cylinder block 22 via the electric wire 8b that electrically connects the ignition coil IG and the ignition plug 6. The ignition plug 6 having applied the secondary voltage in this way applies ignition spark to a mixture of fuel and air present in the combustion chamber of the cylinder block 22.

Subsequently, the mixture of fuel and air in the combustion chamber of the cylinder block 22 having applied ignition spark from the ignition plug 6 as described above is combusted, thereby operating the internal-combustion engine 5. Exhaust gas generated after the combustion is discharged to outside via the exhaust passage 26 and the exhaust pipe 25 in this order.

As a series of operations of the internal-combustion engine 5 as described above was repeated for a predetermined time, there was a case where a driver of a vehicle felt strangeness during driving, such as an output from the internal-combustion engine 5 varied from that of a desired output.

A phenomenon of occurrence of the strangeness during driving in a vehicle is examined below in detail.

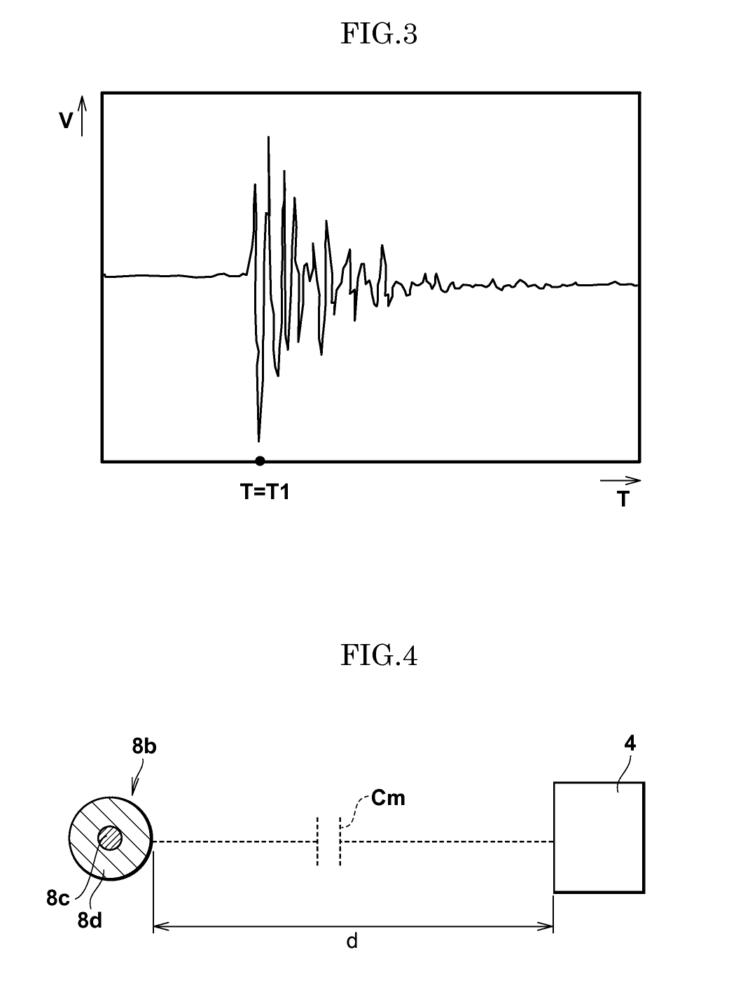

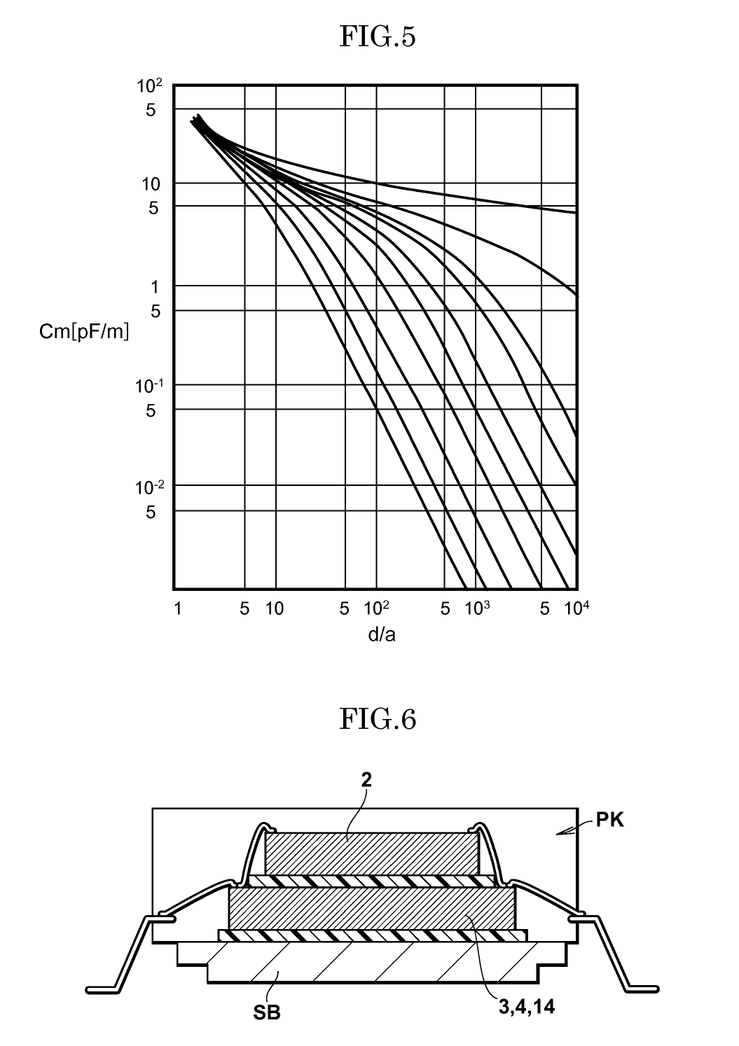

FIG. 3 is a waveform diagram showing a secondary voltage generated in a secondary coil of an ignition coil under control of a microcomputer of the electronic control unit according to the present embodiment, where the horizontal axis represents a time T and the vertical axis represents a voltage V. FIG. 4 is a schematic diagram of an equivalent circuit showing a relationship between a drive circuit and an electric wire that electrically connects an ignition coil and an ignition plug in the present embodiment. FIG. 5 is a graph showing a coupling electrostatic capacity between a drive circuit and an electric wire that electrically connects an ignition coil and an ignition plug in the present embodiment. In FIG. 5, as a diameter of a metal core in the electric wire that electrically connects an ignition coil and an ignition plug is denoted as “a” and a distance (a shortest distance) between a surface of a sheath of the electric wire and a drive circuit is denoted as “d”, the horizontal axis is expressed as “d/a”, and the vertical axis expresses an electrostatic capacity Cm in a case of assuming that air is present between the sheath of the electric wire and the drive circuit.

First, as shown in FIG. 3, when the ignition circuit 3 performed a switching operation under control of the CPU 2, a secondary voltage generated by the ignition coil IG kept its normality as it reached to a predetermined level of high pressure at a time T1 and then attenuated afterwards, even when a driver of a vehicle felt strangeness during driving.

Also fuel supplied to the fuel injection device 7 from the fuel pump 10 via the fuel pipe 11 under control of the CPU 2 kept its normality as it was at a predetermined level of high pressure, even when a driver of a vehicle felt strangeness during driving.

However, operations of the actuator of the fuel injection device 7 electrically connected to the drive circuit 4 via the electric wire 9 under control of the CPU 2 tend to be unstable, and it is thought that this tendency is the cause of a case where a driver of a vehicle feels strangeness during driving, such as an output from the internal-combustion engine 5 varies from that of a desired output.

Furthermore, the cause of the unstableness of operations of the actuator of the fuel injection device 7 is examined below in more detail. That is, when the electric wire 8b that electrically connects the ignition coil IG and the ignition plug 6 is made to contact with the drive circuit 4 that is electrically connected to the fuel injection device 7 via the electric wire 9, there is a phenomenon that not only operations of the actuator of the fuel injection device 7 but also a switching operation of the drive circuit 4 are stopped, whereas operations of the actuator of the fuel injection device 7 and the drive circuit 4 did not stop and maintained to be normal when the electric wire 8b was separated from the drive circuit 4 for approximately 5 cm.

Particularly, when the vehicle is a motorcycle, while the drive circuit 4 is supported in a limited space along with the CPU 2, the internal-combustion engine 5, the fuel tank 30 and the like by the frame 50 within the ECU 1, the electric wire 8b that electrically connects the ignition coil IG and the ignition plug 6 is wired as it is inserted into the head cover 24 of the cylinder 21, which is positioned directly below the frame 50 and arranged to be upright. Therefore, the electric wire 8b and the drive circuit 4 tend to be arranged close to each other. As the electric wire 8b and the drive circuit 4 are arranged to be unnecessarily close to each other, it is thought that this tendency is the cause of a phenomenon of occurrence of strangeness in a vehicle during driving.

Specifically, when conditions of the fuel injection device 7 and the drive circuit 4 were checked as the electric wire 8b is made to contact with the drive circuit 4, there was no abnormality in the fuel injection device 7 and operations thereof as a single unit were normal; however, abnormality was observed in a switching element in the drive circuit 4, and the drive circuit 4 did not operate normally. In this case, as a single unit, no abnormality was observed in the fuel pump 10 that communicates with the fuel injection device 7.

The above result means that, when the electric wire 8b that electrically connects the ignition coil IG and the ignition plug 6 and the drive circuit 4 that is electrically connected to the fuel injection device 7 via the electric wire 9 are arranged to be close to each other, such that the distance (the shortest distance) therebetween is typically 5 cm or less, an electric field caused by a high-voltage secondary voltage flowing in the electric wire 8b generates a surge voltage that exceeds the tolerance of a switching element of the drive circuit 4 that is designed to have high tolerance. It is thought that this phenomenon makes operations of the switching element unstable, and the switching element is damaged in extreme cases.

Furthermore, a relationship between the electric wire 8b and the drive circuit 4 is examined with reference to an equivalent circuit shown in FIG. 4.

Specifically, the electric wire 8b has a metal core 8c such as a copper wire, an outer layer thereof is coated by a sheath 8d that is an electrical insulator made of resin or the like, and electrically connects the ignition coil IG and the ignition plug 6.

Between the electric wire 8b and the drive circuit 4, as far as there is no other constituent elements, air is present therebetween. When the electric wire 8b and the drive circuit 4 are arranged to be unnecessarily close to each other, in such an area where only air is present, an electric field caused by a high-voltage secondary voltage flowing in the metal core 8c of the electric wire 8b is applied to a switching element of the drive circuit 4 as the electric field transcends the sheath 8d of the electric wire 8b, and a surge voltage is induced.

That is, while the surge voltage is generated by a high-voltage secondary voltage flowing in the metal core 8c of the electric wire 8b, because naturally there is a limitation in the tolerance of the drive circuit 4, although it is designed to have high tolerance, if the surge voltage exceeds the tolerance of the drive circuit 4, the switching element thereof is influenced by the surge voltage.

To reduce the surge voltage, it is possible that a metal wire or the like is mixed in the sheath 8d of the electric wire 8b so as to block an electric field caused by a high-voltage secondary voltage flowing in the electric wire 8b, thereby preventing the electric field from leaking outside; however, if this process is employed, the configuration of the electric wire 8b is complicated and it becomes a factor of increasing the weight and cost of the electric wire 8b. In view of this problem, as for the electric wire 8b, it is preferable that such a complicated configuration is not employed, the metal core 8c such as a copper wire is included therein, and a simple configuration such that a metal wire or the like is not mixed on the outer layer and it is coated by a single layer of the sheath 8d made of resin or the like is maintained.

Consequently, because an electric field caused by a high-voltage secondary voltage flowing in the electric wire 8b propagates in a part of air between the metal core 8c of the electric wire 8b and the drive circuit 4, it is considered to be reasonable to actively utilize an electrostatic capacity in the air part between the electric wire 8b and the drive circuit 4 so as to employ a configuration of absorbing a surge voltage generated by the electric field.

When a frequency of a secondary voltage flowing in the metal core 8c of the electric wire 8b is designated as f (Hz), a maximum voltage of the secondary voltage flowing in the metal core 8c of the electric wire 8b is designated as Vng (V), an electrostatic capacity in a case where air is present between the sheath 8d of the electric wire 8b and the drive circuit 4 is designated as Cm (F), an input impedance of the drive circuit 4 is designated as Zi (Ω), and a surge voltage generated in the drive circuit 4 is designated as Vni (V), the surge voltage Vni is expressed by the following equation (Equation 2).

Vni=2π·f·Cm·Zi·Vng [Equation 2]

For example, as the equation (Equation 2) was used to read the frequency f of a secondary voltage and the maximum voltage Vng from a characteristic diagram such as FIG. 3, f and Vng were set as 25×10⁷ (Hz) and 2×10⁴ (V), respectively, the input impedance Zi of the drive circuit 4 was measured as 1274 (Ω), and the electrostatic capacity Cm (F) in a case where air was present between the electric wire 8b and the drive circuit 4 was 2.1×10¹³ (F) to calculate the surge voltage Vni generated in the drive circuit 4, the value was 42 (V), and it resulted to be lower than 60 (V), which was the tolerance voltage of the drive circuit 4.

At this time, the electrostatic capacity Cm in a case where there is air between the sheath 8d of the electric wire 8b and the electric wire 9 can be obtained from the graph shown in FIG. 5. In this case, when the diameter “a” of the metal core 8c of the electric wire 8b is set as 1 (mm) and a diameter including the sheath 8d of the electric wire 8b is set as 7 (mm), the distance d between the surface of the sheath 8d of the electric wire 8b and the drive circuit 4 is 5 (cm). This result straightforwardly corresponds to a fact that, in an actual vehicle, when the electric wire 8b is separated from the drive circuit 4 for 5 cm, operations of an actuator of the fuel injection device 7 and the drive circuit 4 do not stop and are maintained to be normal, and thus the driver of the vehicle does not feel any strangeness in his driving feeling.

Therefore, by using the equation (Equation 2), as the electrostatic capacity Cm in a case where there is air between the sheath 8d of the electric wire 8b and the electric wire 9 is determined so that the surge voltage Vni generated in the drive circuit 4 becomes equal to or larger than the tolerance voltage of the drive circuit 4, and then the distance d between the surface of the sheath 8d of the electric wire 8b and the drive circuit 4 is obtained based on the determined electrostatic capacity Cm, it is possible to determine the shortest distance d allowed between the surface of the sheath 8d of the electric wire 8b and the drive circuit 4, and then an arrangement position where the drive circuit 4 can be arranged with respect to the electric wire 8b that electrically connects an ignition coil and the ignition plug 6 can be determined.

The drive circuit 4 is supported in a limited space along with the CPU 2, the internal-combustion engine 5, the fuel tank 30 and the like by the frame 50 within the ECU 1, and the electric wire 8b is inserted into the insertion hole 29 of the head cover 24 of the cylinder 21, which is positioned directly below the frame 50 and arranged to be upright and then routed, so that the electric wire 8b electrically connects the ignition coil IG and the ignition plug 6. Accordingly, each of the arrangement flexibility of the drive circuit 4, that of both ends of the electric wire 8b, and that within the head cover 24 of the electric wire 8b is limited. Therefore, in order to realize the shortest distance d, in an area between the drive circuit 4 and the head cover 24, a part of the electric wire 8b protruding upward from the insertion hole 29 of the head cover 24 needs to be close to an upper portion of the head cover 24. That is, setting the total length of the electric wire 8b having its both ends defined by the ignition coil IG and the ignition plug 6 as a length required to bring a part of the electric wire 8b protruding upward from the insertion hole 29 of the head cover 24 to be close to an upper portion of the head cover 24 is preferable as a simple and secure configuration. In order to securely bring the part of the electric wire 8b to an upper portion of the head cover 24, although the configuration becomes complicated, it is also possible to hold the electric wire 8b by a holding member (not shown). Alternatively, it is also possible that the shortest distance d between the electric wire 8b and the drive circuit 4 is securely maintained by providing a concave portion on an upper portion of the head cover 24 more intentionally and routing the electric wire 8b while accommodating it in the concave portion.

An implementing configuration between the CPU 2 and the ignition circuit 3, the drive circuit 4, and the input circuit 14 in the above configuration is explained below also with reference to FIG. 6.

FIG. 6 is a cross-sectional view showing a structure in which the microcomputer, the drive circuit and the like according to the present embodiment are arranged in the same package and stacked therein.

As shown in FIG. 6, the ignition circuit 3 electrically connected to the ignition plug 6 by the electric wire 8, the drive circuit 4 electrically connected to the fuel injection device 7 by the electric wire 9, the various input circuits 14 to which a detection signal from the various sensors 13 is input, and the CPU 2 are configured to be sealed in a same package PK such as a casing and to be integrated with each other, and these elements are mounted on a desired support body SB so as to be fixed in a vehicle and the like. For example, the package PK is a resin seal, and it is molded by a transfer molding method and the like. With this configuration, a configuration of a driver device including the ignition circuit 3, the drive circuit 4, the input circuit 14, and the CPU 2 can be made compact.

To specify the distance d between the surface of the sheath 8d of the electric wire 8b and the drive circuit 4 in a case of having a configuration in which the drive circuit 4 and the like and the CPU 2 are sealed in the package PK and are integrated with each other as described above, because the drive circuit 4 is hidden in the package PK and thus it cannot be observed from outside, for convenience, the distance d can be set by using a distance between the surface of the sheath 8d of the electric wire 8b and the package PK having the drive circuit 4 and the like and the CPU 2 sealed therein.

In the present embodiment, the drive circuit 4 electrically connected to the fuel injection device 7 provided in the internal-combustion engine 5 by the electric wire 9 has been explained as an example of an electric circuit that is influenced by an electric field generated by the electric wire 8b that electrically connects an ignition coil and the ignition plug 6; however, it is needless to mention that, as for other types of semiconductor circuits, a spatial electrostatic capacity is set to determine the position of the circuit in a similar manner to that described above.

According to the above configuration, an electric field caused by an electric current flowing in an electric wire that electrically connects an ignition-voltage generating device and an ignition plug induces a surge voltage to a drive circuit via an electrostatic capacity between a drive circuit and an electric wire, and the shortest distance between a drive circuit and an electric wire is set such that the surge voltage becomes equal to or lower than a predetermined surge withstanding capability with which a semiconductor power device of a drive circuit is configured to have high breakdown withstanding capability. Therefore, the surge voltage can be securely reduced with a simple configuration without having even higher breakdown withstanding capability or employing an additional configuration to other electric components or the like that induce the surge voltage, and it is possible to securely prevent the drive circuit from being influenced by an unnecessary surge voltage.

By deciding an electrostatic capacity of a drive circuit and an electric wire that connects an ignition-voltage generating device and an ignition plug such that a surge voltage obtained by the equation (Equation 2) becomes equal to or lower than a predetermined surge withstanding capability, because the shortest distance between the drive circuit and the electric wire is set, the surge voltage can be securely reduced while the drive circuit is arranged based on a unified principle, and it is possible to securely prevent the drive circuit from being influenced by an unnecessary surge voltage.

Even if it is a configuration in which a drive circuit is arranged on an upper portion of an internal-combustion engine, an electric wire that electrically connects an ignition-voltage generating device and an ignition plug extends from an upper part of the internal-combustion engine, and the drive circuit and the electric wire become close to each other, a surge voltage can be securely reduced, and thus it is possible to securely prevent the drive circuit from being influenced by an unnecessary surge voltage.

Even if it is a simple configuration in which an electric wire that electrically connects an ignition-voltage generating device and an ignition plug has a metal core and a sheath coating around the metal core by resin, a surge voltage can be reduced. Therefore, even without employing any electric wire having a unique blocking structure, it is possible to securely prevent the drive circuit from being influenced by an unnecessary surge voltage.

By arranging a drive circuit and a microcomputer in the same package, the entirety of a device configuration can be made compact while securely preventing the drive circuit from being influenced by an unnecessary surge voltage.

In the present invention, the types, arrangements, and numbers of constituent elements are not limited to those described in the above embodiment, and it is needless to mention that changes can be appropriately made without departing from the scope of the invention, such as replacing these constituent elements with other elements having equivalent operational effects.

### INDUSTRIAL APPLICABILITY

As explained above, the present invention can provide an arrangement structure for a semiconductor circuit such as a drive circuit that can absorb a surge voltage securely with a simple configuration, without causing the semiconductor circuit to have even higher breakdown withstanding capability or employing an additional configuration to other electric components or the like that induce a surge voltage. Therefore, the present invention is expected to be widely applicable to a drive device for electric components of a vehicle and the like because of its general-purpose and universal characteristics.

1-5. (canceled)

6. An arrangement structure for a drive circuit, comprising:
a drive circuit that can freely inject fuel from a fuel injection device provided in an internal-combustion engine to the internal-combustion engine under control of a microcomputer; and
an electric wire that electrically connects an ignition-voltage generating device that can freely apply an ignition voltage to an ignition plug provided in the internal-combustion engine and the ignition plug, wherein
the drive circuit includes a semiconductor power device that is configured to have high breakdown withstanding capability to have predetermined surge withstanding capability,
to the drive circuit, an electric field caused by an electric current flowing in the electric wire induces a surge voltage via an electrostatic capacity between the drive circuit and the electric wire, and
there is provided a shortest distance between the drive circuit and the electric wire to be set such that the surge voltage becomes equal to or lower than the predetermined surge withstanding capability of the semiconductor power device based on the electrostatic capacity between the drive circuit and the electric wire, and the drive circuit and the electric wire are arranged relative to each other.

7. The arrangement structure for a drive circuit according to claim 6, wherein when a frequency of the ignition voltage flowing in the electric wire is designated as f (Hz), a maximum voltage of the ignition voltage is designated as Vng (V), the electrostatic capacity in a case where air is present between the electric wire and the drive circuit is designated as Cm (F), an input impedance of the drive circuit is designated as Zi (Ω), and the surge voltage generated in the drive circuit is designated as Vni (V), the shortest distance between the drive circuit and the electric wire is set by determining the electrostatic capacity between the drive circuit and the electric wire such that the surge voltage obtained from following equation (Equation 3) becomes equal to or lower than the predetermined surge withstanding capability of the semiconductor power device.
Vni=2π·f·Cm·Zi·Vng [Equation 3]

8. The arrangement structure for a drive circuit according to claim 6, wherein the drive circuit is arranged on an upper part of the internal-combustion engine, and the electric wire extends from an upper portion of the internal-combustion engine.

9. The arrangement structure for a drive circuit according to claim 6, wherein the electric wire includes a metal core and a sheath coating around the metal core by resin.

10. The arrangement structure for a drive circuit according to claim 6, wherein the drive circuit and the microcomputer are arranged in a same package.
